(19) United States
(12) Patent Application Publication
(10) Pub. No.: US 2018/0101615 A1
(43) Pub. Date: Apr. 12, 2018

(54) SYSTEMS, METHODS AND TECHNIQUES FOR CUSTOMIZABLE DOMAIN-BASED SEARCHING

(71) Applicant: Beijing Century Superstar Information Technology Co., Ltd., Beijing (CN)

(72) Inventor: Chao SHI, Beijing (CN)

(21) Appl. No.: 15/358,334

(22) Filed: Nov. 22, 2016

(30) Foreign Application Priority Data
Oct. 10, 2016 (CN) 201610885146.8

(51) Int. Cl. G06F 17/30

(52) U.S. Cl. CPC G06F 17/30867; G06F 17/30958; G06F 17/30554; G06F 17/30312; G06F 17/30536

(57) ABSTRACT

Systems, methods and techniques for retrieving digital resources from customizable domains in accordance with at least one input search term, are described herein. A plurality of defined domains are defined for users to collect digital resources. Each of the plurality of defined domains represents digital resources filtered out in accordance with at least one specific criterion associated with the domain. At least one input search term is received from a user through a user interface, and then digital resources from each of the plurality of defined domains are extracted in accordance with the input search term. The digital resources extracted from each of the plurality of defined domains are displayed on a screen in association with respective domain. Furthermore, when it is determined that one of the plurality of defined domains is newly created or customized by the user, the domain associated with the user is stored.

### CROSS REFERENCE TO RELATED APPLICATION

This application is based on and incorporates herein by reference Chinese Patent Application No. 201610885146.8 filed on Oct. 10, 2016.

### FIELD OF THE DISCLOSURE

Example embodiments disclosed herein relate generally to searching of digital resources, and more particularly to systems, methods and techniques for customizable domain-based searching on an interactive information platform.

### BACKGROUND AND SUMMARY

Digital resources including multimedia resources have gained in importance with the proliferation of personal electronic devices and the wide availability of Internet. With the widespread use of mobile Internet, it has become more and more convenient to disseminate a large quantity of digital resources using personal devices, such as cellular phones, personal data assistants (PDAs), or personal computer.

However, digital resources are still largely published and delivered in traditional ways similar to the publication of newspapers and magazines, which do not allow readers to specifically customize contents they are interested in. Moreover, conventional content service providers do not allow readers to easily share contents they are interested in with their friends or selected groups. Accordingly, in order to further expand the use and social impact of digital resources, there is a need for retrieving and sharing digital resources in more interactive and effective ways.

To solve the problems identified above, the illustrated example embodiments in this disclosure use social networking environments to disseminate and retrieve digital resources interactively and effectively among users. The illustrated example embodiments provide a method, apparatus, and computer program for an interactive information platform supporting not only content collection and management, but also customizable domain-based content searching, content sharing, and social interactions via social networking environments. By virtue of a social networking environment, users may share or retrieve user-filtered digital resources, and share specific contents with friends, colleagues or people with similar interests. Moreover, historical behaviors of users, such as activities of collecting and reviewing digital resources, can be monitored and evaluated as well.

More specifically, the technology described in this disclosure provides a method, system, and computer program for an interactive information platform supporting customizable domain-based content searching. The interactive information platform establishes a new model of delivering contents to users and sharing contents among users. Through the platform, users are not only able to extract and subscribe to specific contents they are interested in, but also allowed to share their customized contents with other users on the platform.

Conventional search engines provided by companies like Google and Yahoo allow users to search the Internet. These search engines allow a user to access their servers, which store indexes of web page contents available on the Internet. They provide a user with a list of search results after the user inputs search keyword(s). The search results contain hypertext links of web pages, and these hypertext links enable the user to access the indexed web pages. Further, the search results that match the keyword(s) may be ranked through approximating the relevance of searched results, based on the popularity of each search result, for example, based on the number of hyperlinks referred by other websites.

However, these search engines normally provide millions of documents or web pages that match the input keywords. For example, entering the word “Meiling Song” generated about 496,000 results in May 2016 on Google. To further filter out irrelevant search results, entering “Meiling Song” and “book” together results in over 50,400 results. Unfortunately, these search results are not categorized in terms of various types of content, nor are these results extracted or sorted based on their relevancy to the user's true interests or needs.

Regardless of the context in which digital resources are provided to a user, it is often the case that the resources are not as well suited to a user's needs. This is often due to the necessity of generalizing the resources so that they may be retrieved by users having varying needs or interests. For example, two users within the same organization may request resources based on the same search terms, such as “mobile device.” If the first user is a salesman and the second user is a technical staff, it is quite likely that the two users are seeking different resources. The salesman is likely looking for sales information regarding mobile devices and is not interested in detailed technical materials. The technical staff, on the other hand, is likely looking for highly detailed technical materials and is not interested in sales information.

Accordingly, in example embodiments of the present invention, digital resources are categorized into and extracted from various domains. A domain may not only be pre-defined by an interactive information platform, but also be created or customized by a user based on his/her specific needs or interests. A domain represents digital resources filtered out in accordance with at least one specific criterion. In accordance with at least one specific search term input by a user, digital resources are extracted from each of the domains associated with the user and then displayed to the user in association with respective domain.

In certain example embodiments, more than forty domains are originally defined on a platform for users. By default, a predetermined set of system-defined domains are associated with each user on the platform. Users may also create a new domain or customize an existing domain by defining a set of criteria in accordance with their particular needs or interests. For example, a researcher can define a domain representing particular types of digital resources related to his research areas, such as journals proceedings that are related to wireless networking and mobile computing. Moreover, a user may further customize an existing domain in accordance with his searching experiences or his new interests. These user-defined domains are initially stored in association with the corresponding users who created or customized them.

Moreover, users may also perform domain-based searching using domains defined by other users. Users may share their associated domains with other users who might also be interested in digital resources from these domains, such as their friends or colleagues. In some example embodiments, user-defined domains may be available to all the users on a platform.

The technology described in this disclosure is directed to a method for retrieving digital resources from customizable domains in accordance with at least one input search term. The method comprises receiving a plurality of defined domains from which digital resources are collected. Each of the plurality of defined domains represents digital resources filtered out in accordance with at least one specific criterion associated with the domain. The method further comprises receiving at least one input search term from a user through a user interface, extracting digital resources from each of the plurality of defined domains in accordance with the input search term, and displaying, on a user interface, the digital resources extracted from each of the plurality of defined domains in association with respective domain.

Furthermore, the method further comprises determining whether one of the plurality of defined domains is newly created or customized by the user, and then, in response to the determination that one of the plurality of defined domains is newly created or customized by the user, storing the domain associated with the user.

In an example embodiment, the method further comprises receiving from the user an input defining a specific criterion associated with one of the plurality of defined domains. The specific criterion includes, for example, a specific type of digital resources, a specific field, and/or a specific author. The specific type may be bibliography, book, magazine, journal, newspaper, or photograph, etc. The specific field may be science, engineering, literature, art, or sports, etc.

In another example embodiment, the method further comprises receiving from the user a request for subscribing to digital resources from at least one of the plurality of defined domains in accordance with the input search term.

In certain example embodiments, the method further comprises changing a display order of a plurality of display areas corresponding to the plurality of defined domains. A display area corresponding to one of the plurality of defined domains may be moved to be the top one of the plurality of display areas, or the bottom one of the plurality of display areas.

In yet another example embodiment, the method further comprises generating statistical graphs in accordance with the input search term, such as providing a trend analysis based on the extracted search results.

The technology described in this disclosure is also directed to a method comprising recording behaviors of users or events occurred on the interactive information platform. After that, a plurality of assessment records of a user, a course, an application or any kind of objects may be generated based on the recorded user behaviors or events. Each of the generated assessment records may be displayed on a screen as a visual object, which varies in response to its corresponding assessment record. For example, a visual object varies in size, color, or shape according to the value of its corresponding assessment record.

The technology described in this disclosure is also directed to a non-transitory computer readable storage medium storing a computer program having code executable by an information processing apparatus, and the computer program, when executed, causes the information processing apparatus to provide execution comprising receiving a plurality of defined domains from which digital resources are collected. Each of the plurality of defined domains represents digital resources filtered out in accordance with at least one specific criterion associated with the domain. The provided execution also comprises receiving at least one input search term from a user through a user interface, extracting digital resources from each of the plurality of defined domains in accordance with the input search term, and displaying, on a user interface, the digital resources extracted from each of the plurality of defined domains in association with respective domain.

Moreover, the provided execution further comprises determining whether one of the plurality of defined domains is newly created or customized by the user, and then, in response to the determination that one of the plurality of defined domains is newly created or customized by the user, storing the domain associated with the user.

In an example embodiment, the computer program, when executed, further causes the information processing apparatus to provide the execution comprising receiving from the user an input defining a specific criterion associated with one of the plurality of defined domains.

In another example embodiment, the computer program, when executed, further causes the information processing apparatus to provide the execution comprising receiving from the user a request for subscribing to digital resources from at least one of the plurality of defined domains in accordance with the input search term.

In yet another example embodiment, the computer program, when executed, further causes the information processing apparatus to provide the execution comprising changing the display order of a plurality of display areas corresponding to the plurality of defined domains.

Further, the technology described in this disclosure is directed to a system for retrieving digital resources from customizable domains in accordance with at least one input search term. Particularly, the system comprises a processing system having at least one processor, the processing system configured to receive a plurality of defined domains from which digital resources are collected. Each of the plurality of defined domains represents digital resources filtered out in accordance with at least one specific criterion associated with the domain. The processing system is also configured to receive at least one input search term from a user through a user interface, extract digital resources from each of the plurality of defined domains in accordance with the input search term, and then display, on a user interface, the digital resources extracted from each of the plurality of defined domains in association with respective domain.

In addition, the processing system is further configured to determine whether one of the plurality of defined domains is newly created or customized by the user, and then, in response to the determination that one of the plurality of defined domains is newly created or customized by the user, store the domain associated with the user.

In an example embodiment, the processing system is further configured to receive from the user an input defining a specific criterion associated with one of the plurality of defined domains.

In another example embodiment, the processing system is further configured to receive from the user a request for subscribing to digital resources from at least one of the plurality of defined domains in accordance with the input search term.

In yet another example embodiment, the processing system is further configured to change the display order of a plurality of display areas corresponding to the plurality of defined domains.

### BRIEF DESCRIPTION OF THE DRAWINGS

The accompanying drawings facilitate an understand referred embodiments of this invention n such drawings:

FIG. 1 shows a system architecture of a non-limiting example interactive information platform;

FIG. 2 shows a user interface of a non-limiting example interactive information platform;

FIG. 3 shows a workflow of a non-limiting example customizable domain-based searching service;

FIG. 4 shows a non-limiting example user interface displaying digital resources extracted from each of defined domains in accordance with input search term(s).

FIG. 5 shows a non-limiting example user interface enabling a user to define domains associated with the user;

FIG. 6 shows a non-limiting example user interface displaying digital resources in associated with a plurality of domains in a specific order in accordance with input search term(s); and

FIG. 7 shows a user interface displaying a set of visual objects corresponding to assessment records of a user on a non-limiting example interactive information platform.

### DETAILED DESCRIPTION OF EXEMPLARY EMBODIMENTS

In accordance with certain exemplary embodiments, certain systems, device, processes and methods are disclosed for disseminating and collecting digital resources, more particularly, certain exemplary embodiments relate to customizable domain-based searching on an interactive information platform are described herein. In the following description, for purpose of explanation, numerous specific details are set forth to provide a thorough understanding of the exemplary embodiments. It will be evident, however, to a person skilled in that the exemplary embodiments may be practiced without these specific details.

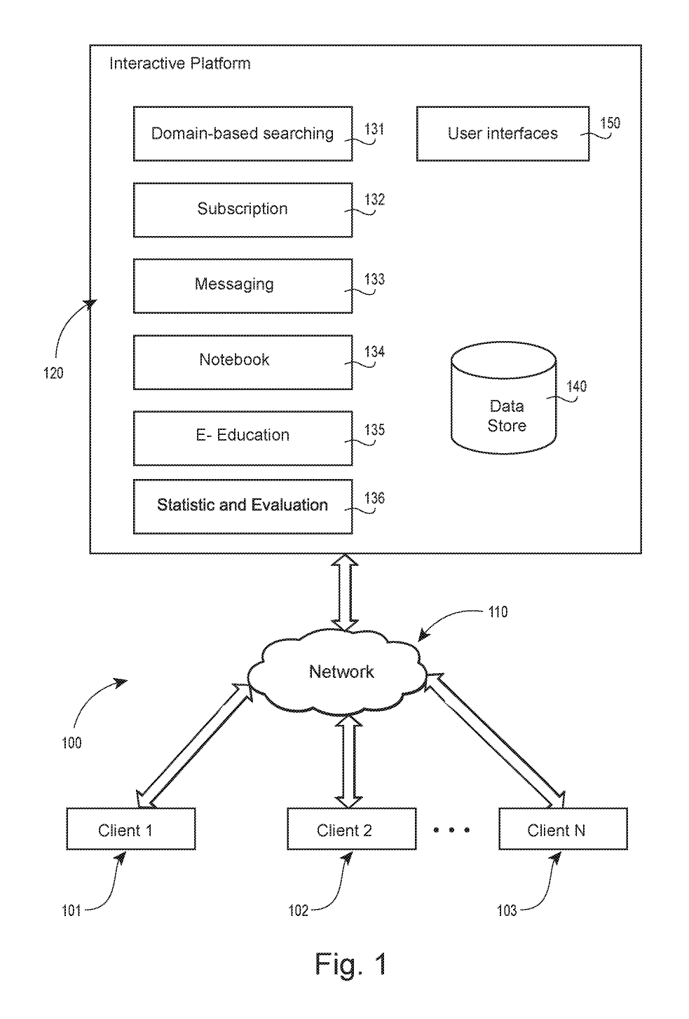

Referring now to FIG. 1, a diagram 100 illustrating the system architecture of an example embodiment of the technology described herein. Some example embodiments may have different and/or other sub-modules than the ones described herein. Similarly, the functions be distributed among the sub-modules in accordance with other embodiments in a different manner than is described herein.

The exemplary system architecture 100 includes a plurality of client electronic devices 101-103, an interactive information platform 120 and a network 110. The client electronic devices 101-103 may be any kinds of computing devices, such as, desktop computers, personal computers (PCs), smart phones, personal digital assistants (PDAs), tablet devices, etc. The client electronic devices 101-103 are communicably coupled to the interactive information platform 120 via the network 110. The network 110 may be a public network (e.g., Internet) or a private network (e.g., Ethernet or a local area Network).

In certain example embodiments, via the client electronic devices 101-103, clients interact with the interactive information platform 120 by exchanging messages or information via standard protocols, e.g., File Transfer Protocol (FTP) and Hypertext Transfer Protocol (HTTP), etc. Each client runs at least one application to generate information or messages to communicate with the interactive information platform 120. In these example embodiments, client electronic devices 101-103 may display graphic user interfaces for users to interact with the platform 120 as well.

The interactive information platform 120 depicted in FIG. 1 provides various services to clients, including, for example, domain-based content searching 131, subscription 132, messaging 133, notebook 134, e-education 135, and statistic and evaluation service 136. The interactive information platform 120 also provides user interfaces 150 for accessing to the services provided by the platform 120. In alternative example embodiments, any one of the services supported by an interactive information platform may be installed locally in a client electronic device.

The domain-based content searching service 131 allows users to define domains representing digital resources filtered out in accordance with their specific needs, and to extract digital resources from various domains in accordance with particular search term(s). Particularly, in accordance with specific search term(s) input by a user, digital resources are extracted from each of the domains associated with the user and then displayed to the user in association with respective domain.

The subscription service 132 allows users to subscribe to specific digital resources. The digital resources to be subscribed include not only digital resources related to specific topics, in particular fields, and/or of particular types, but also on-line educational courses provided by the interactive information platform 120. Moreover, users may subscribe to particular search results generated by domain-based content searching service 131. New resources may automatically be added into the subscribed search results and presented to the subscribed users. Further, users can manage the digital resources they have subscribed to, for example, they may sort their subscribed resources, or create folders to categorize and store the subscribed resources.

The notebook service 134 allows users on the interactive information platform 120 to post notes on their personal spaces on the platform 120, share their notes with a predetermined group of users or all of the users on the platform 120, view notes posted by other users, and comment on notes posted by other users.

The messaging service 133 allows a user of the interactive information platform 120 to send messages to other users, such as friends of the user, company contacts of the user, or contacts within the user's mobile phone. A user may also initiate a group chat among a group of users on the platform 120. The social media based information platform encourages collaboration and engagement amongst users.

The c-education service 135 allows instructors to develop on-line courses via the interactive information platform 120, allows students to participate in one or more on-line courses via the interactive information platform 120, and allows instructors to teach on-line courses.

The statistic and evaluation service 136 generates statistics information based on at least in part upon events detected on the platform. The platform may generate new statistics information whenever one of a predetermined set of events detected. The predetermined events include creating a post, subscribing to an article, adding a friend, creating a course, participating in a course, and so on. Statistics information comprises data that is collected, analyzed or otherwise processed to define one or more quantitative and/or qualitative characteristics about a user, a group of users, an article, a course, or an application, etc. Statistic information may be stored in memory or other storages.

Statistics information reveals characteristics associated with the historical behaviors of a user, e.g., how well a user has finished a quiz, how many articles have been posted by a user, how many books have been subscribed by a user, how many friends a user has, etc. In addition, statistics information also reveals characteristics associated with an article, a course, or an application, or any other kinds of objects on the platform, e.g., how many students have registered for a course, how many users have reviewed an article, how many users have used an application.

The platform may then present statistics information to users to reflect the current characteristics of a user, an article, a book, a course, an application or any other objects on the platform. As detailed below, the statistics information may be presented to users in a textual form, tables, graphics, visual objects, or any other forms.

This interactive information platform 120 involves various technologies, including one-step content retrieval, information collection, digital reading, instant messaging, communication security, message stack pushing, and location based service. Various services, for example the services 131-136, need to work with each other, and be called by each other, and, in the meantime, the platform 120 requires to ensure data security. The platform 120 requires both high stability and scalability, and various modules are organized in a framework with low coupling but high cohesion. Conventional content service providers seldom implement this type of architecture that supports multiple kinds of services, and multiple kinds of terminals (e.g., personal computers, or hand-held terminals, etc.).

In some example embodiments of the present invention, Service Oriented Architecture (SOA) based middleware technology, which is a lightweight Enterprise Service Bus (ESB) architecture, is used to support the provisioning of various services realized from standalone components. The SOA is a technical architecture that defines a way to publish, discover, operate, and manage various services. The architecture combines middleware and web service technologies. It detaches core services from other services and provides interfaces for accessing external services, so that subsystems with required privileges may access to external services via these interfaces. This architecture provides a flexible connectivity framework supporting reliable and secure system integration. A person of ordinary skill in the art would understand that any other architecture may also be utilized to implement the interactive information platform.

In certain example embodiments, services provided by the interactive information platform 120 are not directly interact with each other, but communicate with each other through an ESB, which is an architectural construct used as an intermediary to coordinate the differences due to different systems, communication protocols (e.g., Web Service, HTTP, BON, etc.), or data formats. There may be different types of applications with each comprising a different port type, for example, an application that uses SOAP over HTTP to communicate with the ESB. ESBs can broker various services in a SOA, so that applications do not need to know the identity, physical location, communication protocols, or port definitions of the service providers.

Although the term “ESB service” is used in the disclosure, a person of ordinary skill in the art will understand that the embodiments described herein can be applied to any service provided to a client that communicates with the service by any kinds of messages.

In addition, as shown in FIG. 1, the platform 2120 supports protocol conversion (e.g., Web Service, HTTP, JSON. etc. message transformation (e.g., the conversion, enrichment, or filtration. of a message, etc.), and message routing in various manners (e.g., synchronous/asynchronous, publish/subscribe, content-based routing, or branching and aggregation, etc.). Furthermore, the platform 120 also enables orchestrating multiple services to form a new service.

The interactive information platform 120 includes a data store 140 for storing digital resources and other kinds of data supporting the services provided by the platform. In certain example embodiments, at least a part of the data supporting a provided service may be stored locally in a client electronic device. In certain example embodiments, the platform 120 requires to achieve a throughput at a multi-million level, instantaneously a throughput of 800-1000 per second. A need thus exists for more efficient and reliable data storage and retrieval technologies.

Traditional Relational Database Management Systems (RDBMS's) require expensive hardware and highly skilled personnel. Moreover, a RDBMS typically prefers consistency over performance and availability. To solve these identified issues, NoSQL (Not Only SQL) database management systems (also referred to as non-relational databases or unstructured databases) emerged. A NoSQL database does not require fixed schemas or inherent relations between stored data, and also avoids join operations.

As one kind of NoSQL database, open-source Memcached may be used to implement an example interactive information platform. Memcached is an in-memory non-relational database designed to store a significant portion of data sets in a RAM Memory to make data access much faster than that of a traditional RDBMS. However, Memcached does not support for high-availability and data-persistence. Moreover, during scaling events, Memcached may lose a major portion of its data. Another open-source in-memory non-relational database, Redis, may be used in an example interactive information platform. Redis improves Memcached's functionalities by supporting write operations, persistence storage and high-availability. A person with ordinary skill in the art would understand that any other kinds of databases may be used to implement the interactive information platform.

In some example embodiments of the present invention, to satisfy high-speed reading and writing operations, data sets are stored in a memory. In the meantime, to keep data consistency, distributed data storage systems may also be used in these example embodiments. In a preferred embodiment, logs are first accumulated to a certain degree before they are merged into a memory. Moreover, data sets are preferably continually appended, disks are written sequentially. System performance therefore will not be largely affected by writing operations. A person with ordinary skill in the art would understand that data could be stored or written in any other ways.

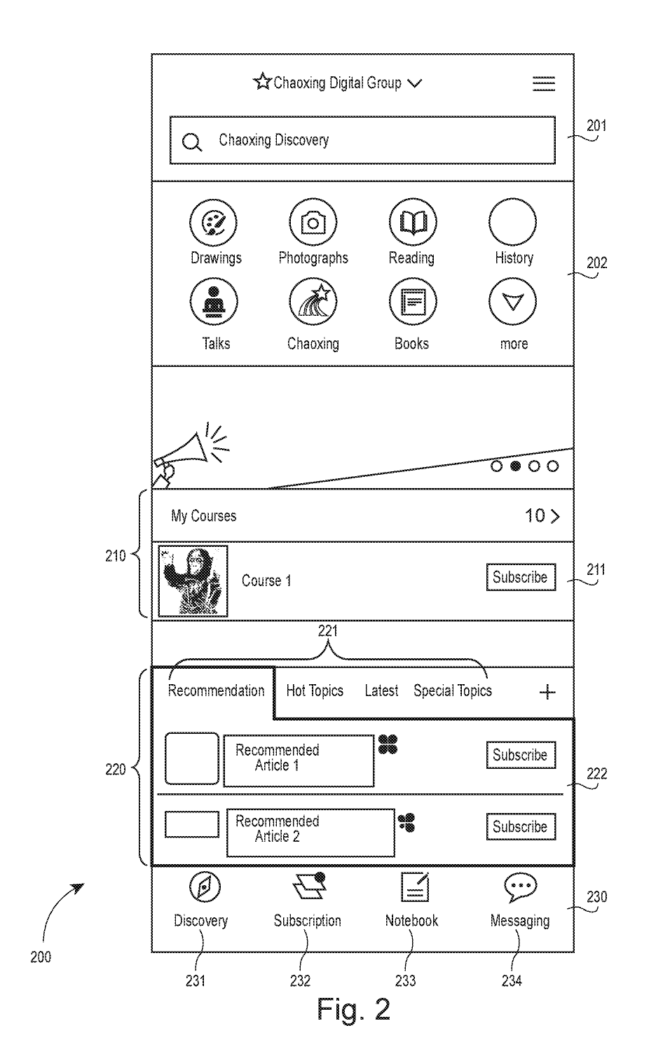

FIG. 2 shows a user interface 200 for a non-limiting example interactive information platform as displayed on the screen of a client electronic device. As can be seen in FIG. 2, this user interface, which is preferably the initial screen displayed to a client, includes a search input field 201, a customizable domain area 202, a “My Courses” area 210, a subscription area 220. and a main menu 230. The main menu 230 enables users to switch between various services provided h the interactive information platform. The main menu 230 includes menu items such as Discovery 231, Subscription 232, Notebook 233, and Messaging 234, which correspond to the customizable domain-based searching service, subscription service, notebook service and messaging service provided by the platform respectively.

On the user interface 200, the “My Courses” area 210 lists a set of courses that are available for participation. The subscription area 220 comprises a plurality of tabs 221 allowing users to view subscribed digital resources from various perspectives, for example, recommended topics, hot topics, latest topics, and special topics. Once one of the plurality of tabs (e.g., a tab 222 for displaying recommended topics) is selected by a user, its corresponding topics (e.g., the recommended topics) are displayed in the tab. Up and down arrows or scroll bars may be provided for stepping through or scrolling around these areas.

The menu item “Discovery” 231 corresponds to a customizable domain-based searching service provided by the interactive information platform. As shown in FIG. 2, the customizable domain area 202 lists various domains from which digital resources are retrieved. A domain represents digital resources filtered out in accordance with one or more criteria associated with the domain. In accordance with a criterion associated with the domain, digital resources of one or more types may be filtered out, for example, bibliography, books, scholarly journals, popular periodicals, and/or dissertations, and so on. Moreover, one of the criteria may also be used to filter out digital resources in one or more specific fields including, for example, science, engineering, literature, art, or sports. Further, one of the criteria may also be used to filter out digital resources of a specific author. Some example domains may also represent digital resources filtered out based on a combination of various criteria.

The search input field 201 allows users to input at least one search term for retrieving digital resources from the plurality of defined domains listed in the customizable domain area 202 in accordance with the input search term.

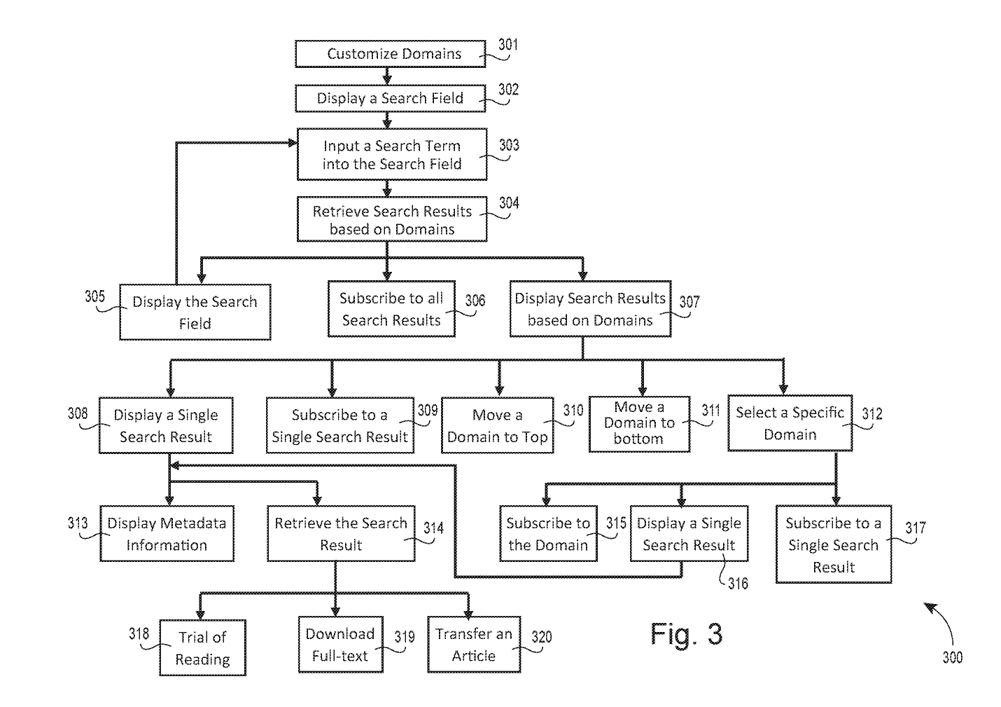

FIG. 3 shows a workflow 300 of a non-limiting example customizable domain-based searching service for retrieving digital resources from customizable domains in accordance with at least one input search term.

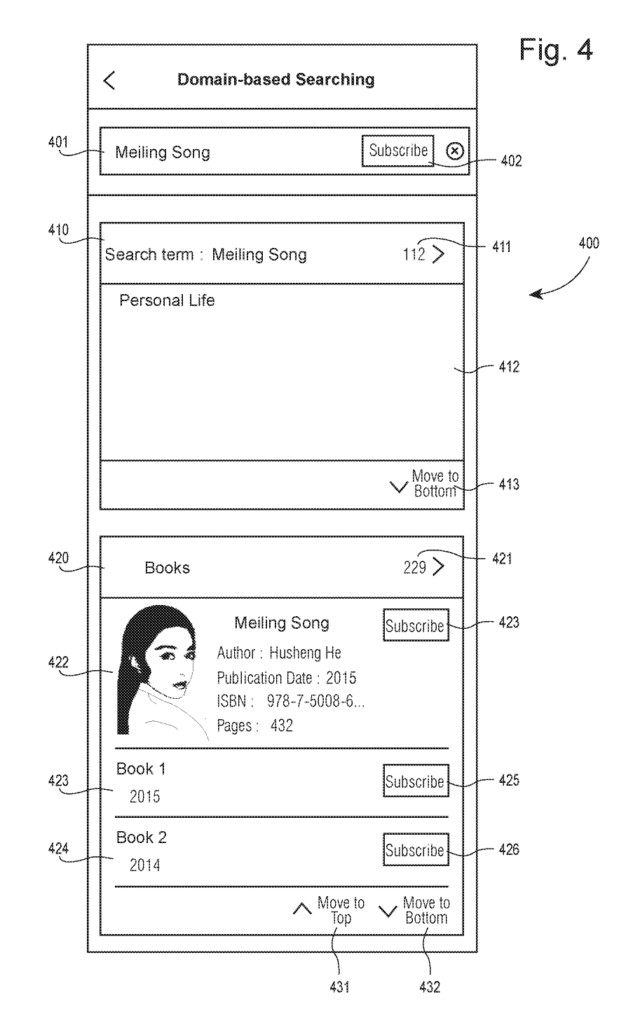

Referring to FIG. 3, in step 301, a user may use a plurality of domains on the interactive information platform defined by the platform or other users, or define domains in accordance with her/his specific interests if necessary. The interactive information platform may already define a plurality of domains as default domains, such as domains representing bibliography, books, patents, people, or images, etc. A predetermined set of system-defined default domains may be initially associated with each user on the platform. As discussed above with respect to FIG. 2, a search field is displayed on a screen to allow users to input search terms for their specific queries in step 302. At least one search term is input by the user as an input search term in step 303, based on which digital resources are extracted from the defined domains in step 304. In step 307, the search results extracted from each of the defined domains are displayed in various display areas of the screen corresponding to respective domain, as shown in FIG. 4. The extracted digital resources are displayed in association with the specific domains they belong to. After the execution of the query, the search field is displayed again on the screen in step 305.

The display order of the various display areas corresponding to the defined domains may be changed by the user. For example, the user may move one of the display areas to be the top one of the display areas in step 310, or move one of the display areas to be the bottom one of the display areas in step 311.

The user may subscribe to all of the search results extracted in accordance with the input search term in step 306 or subscribe to a single search result extracted in accordance with the input search term in step 309. In addition, the user may select a specific domain in step 312 to display digital resources extracted from the domain in accordance with the input search term. After the selection of the specific domain, the user may subscribe to all of the digital resources extracted from the specific domain in accordance with the input search term in step 315, or subscribe to a single search result extracted from the domain in accordance with the input search term in step 317.

Moreover, the user may also select to display a single search result extracted from the domain in accordance with the input search term in step 316. In step 308, a single search result may be displayed upon the user's selection. In displaying details of the single search result, metadata information of the search result may be displayed in step 313. In step 314, the user may select to retrieve the single search result in various manners, including downloading the full-text of an article in step 319, transferring an article in step 320, or a free trial of reading in step 318. A search result may also be acquired by the user in any other manners.

FIG. 4 shows a non-limiting example user interface displaying digital resources extracted from defined domains in accordance with at least one input search term.

After a user inputs “Meiling Song” into a search input field 401 in order to search digital resources from various defined domains in accordance with the input search terms—“Meiling Song,” digital resources will be extracted from each of the defined domains in accordance with the input search terms, and then displayed in associated with respective domain.

In the example user interface, digital resources are extracted from defined domains, including a domain representing digital resources related to “personal life,” and another domain representing digital resources that are “Books.” In accordance with the input search terms, various digital resources are extracted from each of these defined domains and then displayed associated with respective domain, for example, in display areas 410 and 420 corresponding to the defined “Personal Life” domain and “Books” domain. As shown in an area 411 on the top right corner of the display area 410, a total of 112 search results are extracted from the “Personal Life” domain. An area 421 on the top right corner of the display area 420 indicates that a total of 229 search results are extracted from the “Books” domain.

In particular, in accordance with the input search terms—“Meiling Song,” information about the personal life of “Meiling Song” is displayed in area 412 within the display area 410, and a list of books related to “Meiling Song” are displayed in areas 422, 423, and 424 within the display area 420. The user may select one of the books listed in the display area 420, and then detailed information (e.g., metadata) of the selected book may be displayed. By default, detailed information of the first book is displayed in the area 422.

In addition, the user may subscribe to any of the books listed in the display area 420 corresponding to the “Books” domain by clicking on one of “Subscribe” buttons 423, 425, and 426. There is a “Subscribe” button 402 adjacent to the search input field 401 as well. The “Subscribe” button 402 allows the user to subscribe to all of the digital resources extracted from the defined domains in accordance with the input search terms—“Meiling Song.”

The user may also choose to change a display order of the display areas corresponding to the defined domains. By clicking on a “Move to Top” icon 431 or a “Move to Bottom” icon 432 at the bottom of the display area 420, the display area 420 may be moved to be the top one of the plurality of display areas, or the bottom one of the plurality of display areas. As a result, the extracted digital resources can be displayed in an order preferred by the user. In other example embodiments, a user may change locations of these display areas on a screen in any other ways, such as by a drag and drop action.

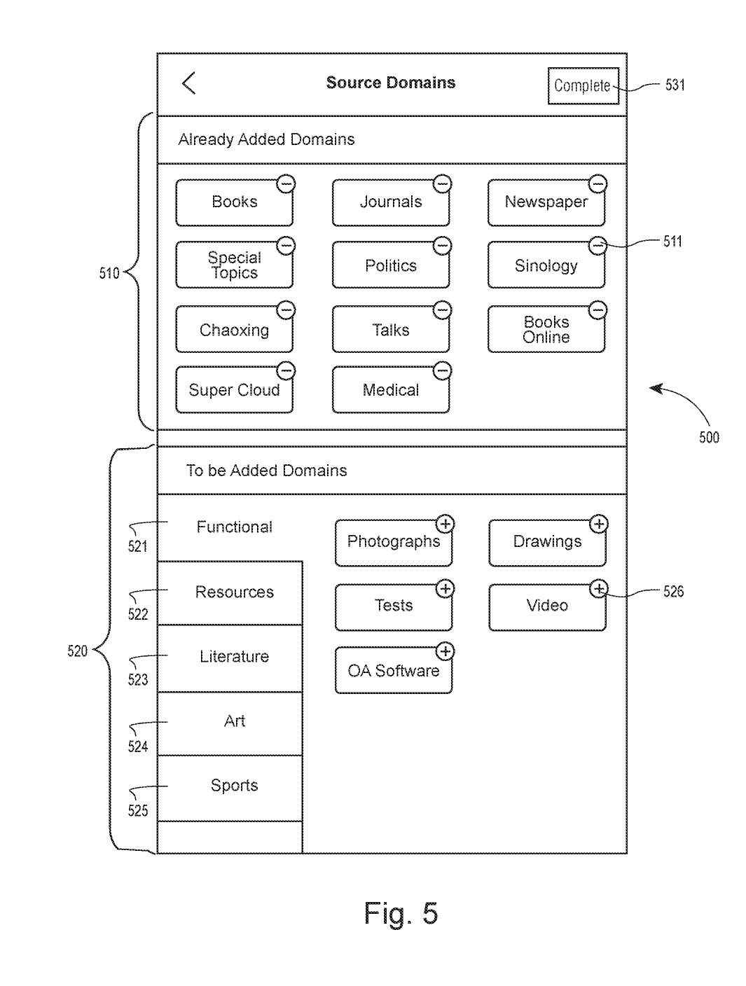

Turning now to FIG. 5, a non-limiting example user interface 500 enables a user to define domains associated with the user. A user may extract digital resources from a set of domains defined on an interactive information platform in accordance with specific search terms. A domain represents digital resources filtered out in accordance with one or more particular criteria. accordance with the criteria associated with the domain, digital resources of one or more specific types may be filtered out, such as bibliography, books, scholarly journals, popular periodicals, and/or dissertations, and so on. Moreover, the criteria may also be used to filter out digital resources in a specific field including, for example, science, engineering, literature, art, or sports.

The example interactive information platform may pre-define a set of domains for users to extract digital resources from any of these domains. The user interface 500 includes a display area 510 displaying a set of domains already added as defined domains associated with a user, including Books, Journals, Newspaper, Special topics, Politics, Sinology, Chaoxing, Talks, Books Online, Super Cloud, and Medical. The user may remove any of the existing domains from her/his associated domains by clicking on a minus icon 511 at the top right corner of each of the associated domains. In another example embodiments, the user may drag and drop a domain from the display 510 into the display area 520 to remove the domain.

In addition, the user interface 500 also includes another display area 520 that allows the user to add pre-defined domains into her/her associated domains. The pre-defined domains include domains defined by the platform or other users. The default domains are categorized to make it easier for users to select specific domains matching their needs. For example, default domains may include domains categorized as being related to functional digital resources, resources, literature, art, and sports, as shown in tabs 521-525 in the display area 520. To add a new domain, the user may click on a plus icon 526 at the top right corner of each of the domains displayed in the display area 520. In another example embodiments, the user may drag and drop a domain from the display 520 into the display area 510 to add the domain into his associated domains. The user may also add or customize a new domain via any other kinds of ways. Once the user finishes defining domains associated with her/him, the user may click on a “Complete” button 531 at the top right corner of the user interface 500 to complete the process of defining domains.

A non-limiting example interactive information platform also allows users to define new domains or customize existing domains in accordance with their specific interests or needs. These domains are stored in association with the users who created or customized them. Users may define a specific criterion associated with a domain, or modify one of the criteria associated with an existing domain. For example, an artist may define a domain representing digital resources related to European classic oil paintings, and then further define the domain to represent digital resources related to oil paintings by a specific artist, such as William Powell Frith. When the platform determines that a domain is newly created or customized by a user, it stores the domain associated with the user.

Moreover, users may share their associated domains with other users who might also be interested in digital resources from these domains, such as their friends, colleagues or people with similar interests. In some example embodiments, user-defined domains may be available to all the users on an interactive information platform. Users may perform domain-based searching using domains generated or customized by other users, or subscribe to digital resources extracted from domains associated with other users.

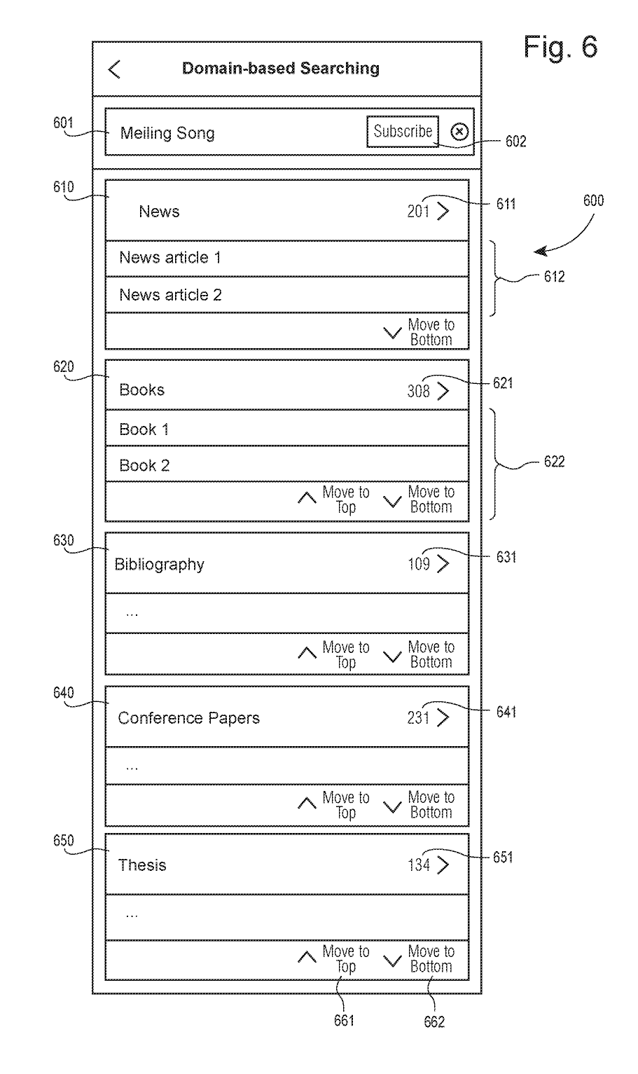

FIG. 6 shows another non-limiting example user interface 600 displaying digital resources in associated with a plurality of domains in a specific order in accordance with input search term(s).

After a user inputs “Meiling Song” into a search input field 601 to search relevant digital resources from various defined domains, digital resources will be extracted from each of the defined domains in accordance with the input search terms, and then displayed in associated with respective domain.

In the user interface 600, digital resources are extracted from various domains, including “News” domain, “Books” domain, “Bibliography” domain, “Conference Papers” domain, and “Thesis” domain. Each domain may represent a specific category or a specific type of resources. In accordance with the input search terms, various digital resources are extracted from each of these domains and then displayed associated with respective domain, for example, in display areas 610, 620, 630, 640 and 650 corresponding to the “News” domain, “Books” domain, “Bibliography” domain, “Conference Papers” domain, and “Thesis” domain respectively.

At the top right corner of each of the display areas 610, 620, 630, 640 and 650, it displays a total number of search results extracted from the corresponding domain. For example, an area 611 on the display area 610 indicates that a total of 201 search results are extracted from the “News” domain, an area 621 on the display area 620 indicates that a total of 229 search results are extracted from the “Books” domain, an area 631 on the display area 630 indicates that a total of 109 search results are extracted from the “Bibliography” domain, an area 641 on the display area 640 indicates that a total of 231 search results are extracted from the “Conference Papers” domain, and an area 651 on the display area 650 indicates that a total of 134 search result are extracted from the “Thesis” domain.

In particular, in accordance with the input search terms—“Meiling Song,” news related to “Meiling Song” are displayed in an area 612 within the display area 610, and a plurality of books related to “Meiling Song” are displayed in an area 622 within the display area 620. The user may select one of the books listed in the display area 622, and then detailed information (e.g., metadata) of the selected book may be displayed. Certain information of one of the books may be displayed when a user moves his mouse or finger over a specific book.

In addition, there is a “Subscribe” button 602 adjacent to the search input field 601 as well. The “Subscribe” button 602 allows the user to subscribe to all of the digital resources extracted from the defined domains in accordance with the input search terms—“Meiling Song.”

The plurality of domains are displayed on a screen to a user in a specific order. A default display order for various domains may be pre-defined for these domains initially. The user may re-arrange the display order of these domains, such as to prioritize the domains in which the user is more interested. Moreover, the user may also delete certain domains that he/she is not interested in.

For example, by clicking on a “Move to Top” icon 661 or a “Move to Bottom” icon 662 at the bottom of the display area 650, the display area 650 may be moved to be the top one of the plurality of display areas, or the bottom one of the plurality of display areas. As a result, the extracted digital resources can be displayed in an order preferred by the user. In other example embodiments, a user may change locations of these display areas on a screen in any other ways, such as by a drag and drop action.

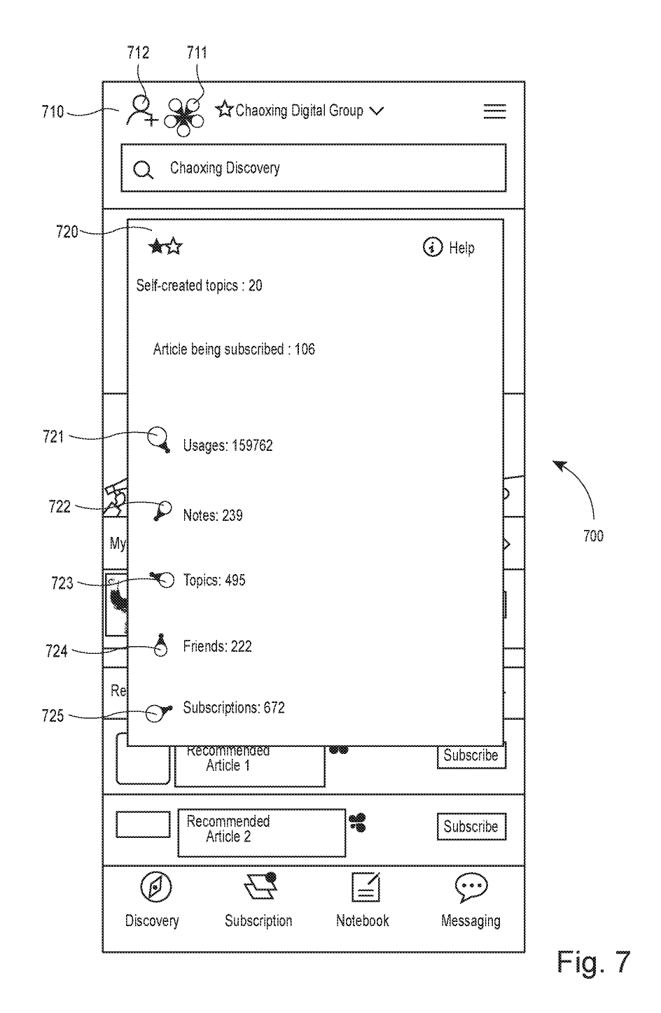

FIG. 7 shows a user interface 700 displaying a set of visual objects corresponding to assessment records of a user on a non-limiting example interactive information platform.

The interactive information platform may monitor and record the behaviors of a user, such as posting messages or articles, completing assignments or tests, reading articles, or participating in a class, etc. The platform may generate new statistics information whenever one of a predetermined set of events detected. The predetermined set of events include creating a post, subscribing to an article, adding a friend, creating a course, participating a course, and so on.

The platform generates assessment records for users or resources on it. The assessment information comprises a summary or analysis of any suitable qualitative and/or quantitative data that represents various characteristics about a user, a group of users, a course, an article, an application, etc. For example, assessment records are generated for the user based on the recorded statistics information regarding user behaviors. The assessment records include, for example, the number of messages or articles posted by the user, the number of assignments or tests completed by the user, the number of articles read by the user, or the attendance of the user.

As shown in FIG. 7, the user interface 700 includes a display area 710 indicating a specific user of the platform, and a pop-up dialog 720 displaying assessment records of the specific user. In the pop-up dialog 720, it shows that the user has created 20 topics, and 106 articles created by the user are subscribed. In addition, the dialog 720 also displays information regarding other assessment records of the user, including 159762 usages, 239 notes, 495 topics, 222 friends, and 762 subscriptions. Furthermore, the dialog 720 also shows a set of visual objects 721-725, corresponding to certain assessment records of the user: the number of usages, the number of notes, the number of topics, the number of friends, and the number of subscriptions respectively.

In an example embodiment, the size of a visual object may become larger as the value of its corresponding assessment record increases, and the color of a visual object may change as the value of its corresponding assessment record is larger than a predetermined number. In addition, as shown in the user interface 700, each of the displayed visual objects is a petal of a flower, and all of the visual objects corresponding to the assessment records of the user are combined together to be a flower 711 displayed in the display area 710 in association with a user icon 712. As a result, the current status of each user on the platform can be clearly illustrated by the combination of the visual objects in association with the user, for example, the bigger the user's flower is, the more experienced the user is.

In an alternative example embodiment, assessment records of users may be illustrated through any other kinds of forms, such as statistical graphs or tables.

In a further example embodiment, the platform generates various statistical graphs in accordance with input search terms, such as providing a trend analysis based on the extracted search results. The platform can determine digital resources accumulated in each domain. On the other hand, the platform monitors and evaluates detailed behaviors of users, such as activities of collecting and reviewing digital resources. As a result, the platform can analyze digital resources in each domain and the historical behaviors of users to provide the latest trend of specific digital resources. Further, the statistical data provided by the interactive information platform may also be used to facilitate office operations, decision making and HR management.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

What is claimed is:

1. A method for retrieving digital resources from customizable domains in accordance with at least one input search term, comprising:
receiving a plurality of defined domains from which digital resources are collected, each of the plurality of defined domains representing digital resources filtered out in accordance with at least one specific criterion associated with the domain;
receiving at least one input search term from a user through a user interface;
extracting digital resources from each of the plurality of defined domains in accordance with the input search term;
displaying, on a user interface, the digital resources extracted from each of the plurality of defined domains in association with respective domain;
determining whether one of the plurality of defined domains is newly created or customized by the user; and
in response to the determination that one of the plurality of defined domains is newly created or customized by the user, storing the domain associated with the user.

2. The method of claim 1, further comprising receiving from the user an input defining a specific criterion associated with one of the plurality of defined domains.

3. The method of claim 1, further comprising receiving from the user a request for subscribing to digital resources from at least one of the plurality of defined domains in accordance with the input search term.

4. The method of claim 1, further comprising changing a display order of a plurality of display areas corresponding to the plurality of defined domains.

5. The method of claim 4, further comprising moving a display area corresponding to one of the plurality of defined domains to be the top one of the plurality of display areas.

6. The method of claim 4, further comprising moving a display area corresponding to one of the plurality of defined domains to be the bottom one of the plurality of display areas.

7. The method of claim 1, wherein the specific criterion specifies digital resources of a specific type, in a specific field, and/or of a specific author.

8. The method of claim 7, wherein the specific type is bibliography, book, magazine, journal, newspaper, or photograph.

9. The method of claim 7, wherein the specific field is science, engineering, literature, art, or sports.

10. The method of claim 1, further comprising generating statistical graphs in accordance with the input search term.

11. A non-transitory computer readable storage medium storing a computer program having code executable by an information processing apparatus, the computer program, when executed, causing the information processing apparatus to provide execution comprising:
receiving a plurality of defined domains from which digital resources are collected, each of the plurality of defined domains representing digital resources filtered out in accordance with at least one specific criterion associated with the domain;
receiving at least one input search term from a user through a user interface;
extracting digital resources from each of the plurality of defined domains in accordance with the input search term;
displaying, on a user interface, the digital resources extracted from each of the plurality of defined domains in association with respective domain;
determining whether one of the plurality of defined domains is newly created or customized by the user; and
in response to the determination that one of the plurality of defined domains is newly created or customized by the user, storing the domain associated with the user.

12. The non-transitory computer readable storage medium of claim 11, wherein the execution further comprises receiving from the user an input defining a specific criterion associated with one of the plurality of defined domains.

13. The non-transitory computer readable storage medium of claim 11, wherein the execution further comprises receiving from the user a request for subscribing to digital resources from at least one of the plurality of defined domains in accordance with the input search term.

14. The non-transitory computer readable storage medium of claim 11, wherein the execution further comprises changing the display order of a plurality of display areas corresponding to the plurality of defined domains.

15. The non-transitory computer readable storage medium of claim 11, wherein the specific criterion specifies digital resources of a specific type, in a specific field, and/or of a specific author.

16. A system for retrieving digital resources from customizable domains in accordance with at least one input search term, comprising:
a processing system having at least one processor, the processing system configured to:
receive a plurality of defined domains from which digital resources are collected, each of the plurality of defined domains representing digital resources filtered out in accordance with at least one specific criterion associated with the domain;
receive at least one input search term from a user through a user interface;
extract digital resources from each of the plurality of defined domains in accordance with the input search term;
display, on a user interface, the digital resources extracted from each of the plurality of defined domains in association with respective domain;
determine whether one of the plurality of defined domains is newly created or customized by the user; and
in response to the determination that one of the plurality of defined domains is newly created or customized by the user, store the domain associated with the user.

17. The system of claim 16, wherein the processing system is further configured to receive from the user an input defining a specific criterion associated with one of the plurality of defined domains.

18. The system of claim 16, wherein the processing system is further configured to receive from the user a request for subscribing to digital resources from at least one of the plurality of defined domains in accordance with the input search term.

19. The system of claim 16, wherein the processing system is further configured to change a display order of a plurality of display areas corresponding to the plurality of defined domains.

20. The system of claim 16, wherein the specific criterion specifies digital resources of a specific type, in a specific field, and/or of a specific author.
